(19) United States
(12) Patent Application Publication
(10) Pub. No.: US 2015/0356853 A1
(43) Pub. Date: Dec. 10, 2015

(54) ANALYZING ACCELEROMETER DATA TO IDENTIFY EMERGENCY EVENTS

(71) Applicant: GrandiOs Technologies, LLC, Wilmington, DE (US)

(72) Inventor: John Cronin, Bonita Springs, FL (US)

(21) Appl. No.: 14/625,598

(22) Filed: Feb. 18, 2015

Related U.S. Application Data
(60) Provisional application No. 62/007,772, filed on Jun. 4, 2014.

(51) Int. Cl. G08B 21/18

(52) U.S. Cl. CPC G08B 21/182

(57) ABSTRACT

Methods and systems are presented for analyzing accelerometer motion data on a user device. A motion application may monitor accelerometer data feeds in real time to identify an emergency event and to send an emergency notification to one or more emergency contacts. Motion application functions may be embedded in the operating system of a user device. The motion application functions provide for local and non-local real time data analysis and verification of accelerometer data from a user device to identify a verified emergency event.

### CROSS-REFERENCE TO RELATED APPLICATIONS

The present application claims the priority benefit of U.S. provisional application No. 62/007,772 filed Jun. 4, 2014 and entitled “Analyzing Accelerometer Data to Identify Emergency Events,” the disclosure of which is incorporated herein by reference.

### BACKGROUND OF THE INVENTION

1. Field of the Invention

The present invention generally concerns accelerometer data on a user device. More particularly, the present invention concerns analyzing accelerometer data on a user device to identify emergency events.

2. Description of the Related Art

User devices (e.g., smartphones) typically have a built-in accelerometer, which allows the device to detect physical movement. Existing software applications perform functions that utilize accelerometer data. For example, a software application may use accelerometer data to detect impacts (e.g., the user is in an automobile accident or the user falls) and to subsequently trigger an automatic emergency call. Control of the accelerometer of a user device is currently limited to a single function in the operating system settings of the device that may be used to turn the accelerometer on or off. Because control of the accelerometer in the operating system is limited, existing applications do not link accelerometer data from one source to accelerometer data from other sources.

Existing accelerometer applications do not provide functionality for verifying emergency events using accelerometer data from more than one source. Similarly, existing accelerometer applications do not provide functionality for remote, real time third party access and analysis of the accelerometer data from a user device.

Thus, there exists a need for analyzing accelerometer data from a user device, in accordance with user settings or preferences, in order to identify situations where emergency assistance may be necessary.

### SUMMARY OF THE CLAIMED INVENTION

Methods and systems are presented for analyzing accelerometer motion data on a user device. A motion application may monitor accelerometer data feeds in real time to identify an emergency event and to send an emergency notification to one or more emergency contacts. Motion application functions may be embedded in the operating system of a user device. The motion application functions provide for local and non-local real time data analysis and verification of accelerometer data from a user device to identify a verified emergency event.

Various embodiments may include methods for analyzing accelerometer data on a user device. One such method may include receiving first accelerometer data in real time from a first data source and receiving second accelerometer data in real time from a second data source. The method may also include analyzing the received first accelerometer data over time to identify one or more first potential emergency events where each of the first potential emergency events is associated with a respective first event time window, as well as analyzing the received second accelerometer data over time to identify one or more second potential emergency events where each of the second potential emergency events is associated with a respective second event time window. The method may also include comparing the first potential emergency events and the second potential emergency events to identify one or more verified emergency events when a first event time window associated with a first potential emergency event and a second event time window associated with a second potential emergency event overlap in time. The method may also include generating an emergency notification based on the identified one or more verified emergency events.

Various embodiments may further include apparatuses for analyzing accelerometer data on a user device. One such apparatus may include an interface that receives first accelerometer data in real time from a first data source and second accelerometer data in real time from a second data source. The apparatus also includes a memory that stores instructions and a processor that executes the instructions stored in the memory to analyze the received first accelerometer data over time to identify one or more first potential emergency events, to analyze the received second accelerometer data over time to identify one or more second potential emergency events, to compare the first potential emergency events and the second potential emergency events to identify one or more verified emergency events based on a first event time window associated with a first potential emergency event and a second event time window associated with a second potential emergency event overlapping in time. The processor may further execute instructions to generate an emergency notification based on the identified one or more verified emergency events.

Embodiments of the present invention may further include non-transitory computer-readable storage media, having embodied thereon a program executable by a processor to perform methods for analyzing accelerometer data on a user device as described herein.

### BRIEF DESCRIPTION OF THE DRAWINGS

FIG. 1 illustrates an exemplary network environment in which a system for analyzing accelerometer data on a user device may be implemented.

FIG. 2 is a diagram illustrating exemplary settings of an operating system on a user device that may be used with a system for analyzing accelerometer data on a user device.

FIG. 3 is table illustrating exemplary combinations of first and second data sources.

FIG. 4 is a flowchart illustrating an exemplary method for analyzing accelerometer data on a user device.

FIG. 5 is an exemplary diagram for analyzing accelerometer data from first and second data sources on a user device.

FIG. 6 is a flowchart illustrating another exemplary method for analyzing accelerometer data on a user device.

FIG. 7 illustrates a mobile device architecture that may be utilized to implement the various features and processes described herein.

### DETAILED DESCRIPTION

Methods and systems are presented for analyzing accelerometer data at an operating system of a user device in order to identify emergency events. In some embodiments, at least two real time data feeds from at least two data sources (e.g., sensors) may be analyzed to identify an emergency event. In some embodiments, local and remote analyses of motion activity data feeds from data sources may be used to identify an emergency event in real time. In some embodiments, an emergency notification may be sent to one or more specified emergency contacts. In one embodiment, the motion activity system provides a real time emergency notification function embedded in the operating system of a user device.

Access to and uses of accelerometer data on a user device may be customized based on user settings. Devices from which to retrieve accelerometer data (e.g., a smart watch) may also be customized based on user settings. User settings, including accelerometer settings, may be inputted at the user device, stored locally on the user device, and used by the user device operating system to control accelerometer actions. In some embodiments, as permitted by accelerometer settings, a motion application on the user device may analyze accelerometer data and other local data to identify an emergency event. In some embodiments, this analysis is performed in real-time by the operating system of the user device.

In some embodiments, the accelerometer data and/or emergency event data from a user device is verified. As permitted by the accelerometer settings, emergency event data is sent by the user device to a third party server, where the emergency event data may be verified based on accelerometer data received from other user devices. In some embodiments, one or more functions (e.g., calendar application functions) embedded in the operating system of the user device may be linked to the accelerometer function and used to verify the accelerometer data. In some embodiments, one or more external devices that include an accelerometer (e.g., a smart watch) may be used to verify the accelerometer data from a user device.

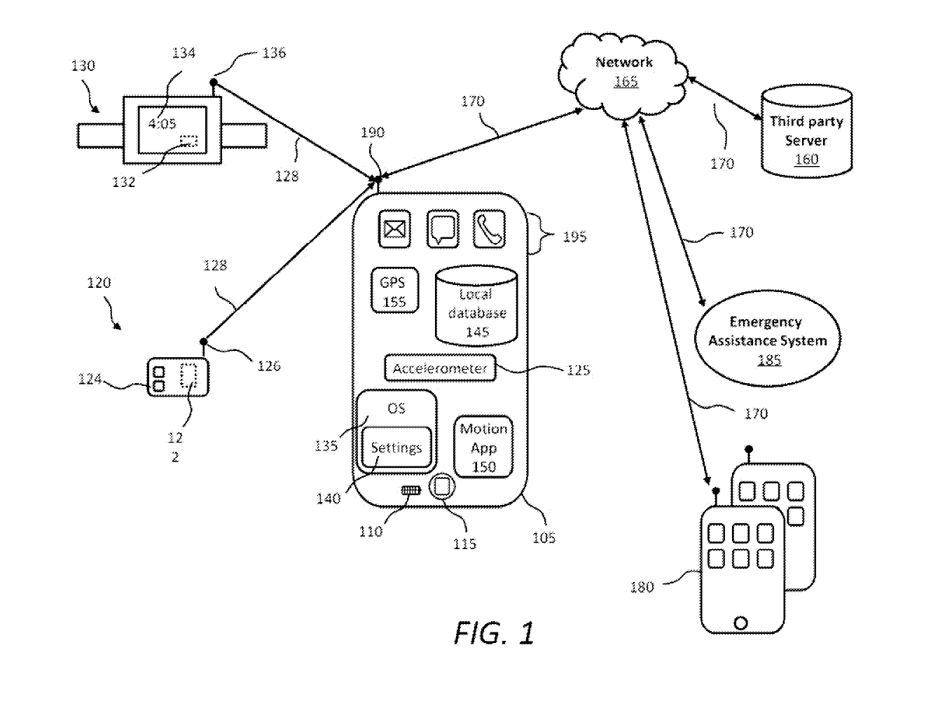

FIG. 1 illustrates an exemplary network environment 100 in which a system for analyzing accelerometer data on a user device may be implemented. Network environment 100 may include user device 105, network 165, network connections 170, health monitor device 120, smart watch 130, third party server 160, emergency assistance system 185, and receiver devices 180. Any combination of the components illustrated in network environment 100, including user device 105, network 165, network connections 170, health monitor device 120, smart watch 130, third party server 160, emergency assistance system 185, and receiver devices 180, and blocks, processes, or subsystems of each, and any other hardware, software, or both, for implementing the features described in the present disclosure may be collectively referred to, herein, as “the system.”

User device 105 may be any number of different electronic user devices 105, such as general purpose computers, mobile phones, smartphones, personal digital assistants (PDAs), portable computing devices (e.g., laptop, netbook, tablet), desktop computing devices, handheld computing device, or any other type of computing device capable of communicating over network 165. User device 105 may also be configured to access data from other storage media, such as memory cards or disk drives as may be appropriate in the case of downloaded services. User device 105 may include standard hardware computing components, including, for example, network and media interfaces, non-transitory computer-readable storage (memory), and processors for executing instructions that may be stored in memory.

In the illustrated embodiment, user device 105 (e.g., a smartphone) includes a display (not shown). In some implementations, the display may be a touchscreen display. In some implementations, the display is a user interface. As shown in the illustrated embodiment, the display may display icons corresponding to applications 195. The display may include any suitable soft keys. User device 105 may also include microphone 110 and on/off button 115. It will be understood that user device 105 may include other elements not shown, for example, a speaker, camera, light, or any other suitable hardware or software elements.

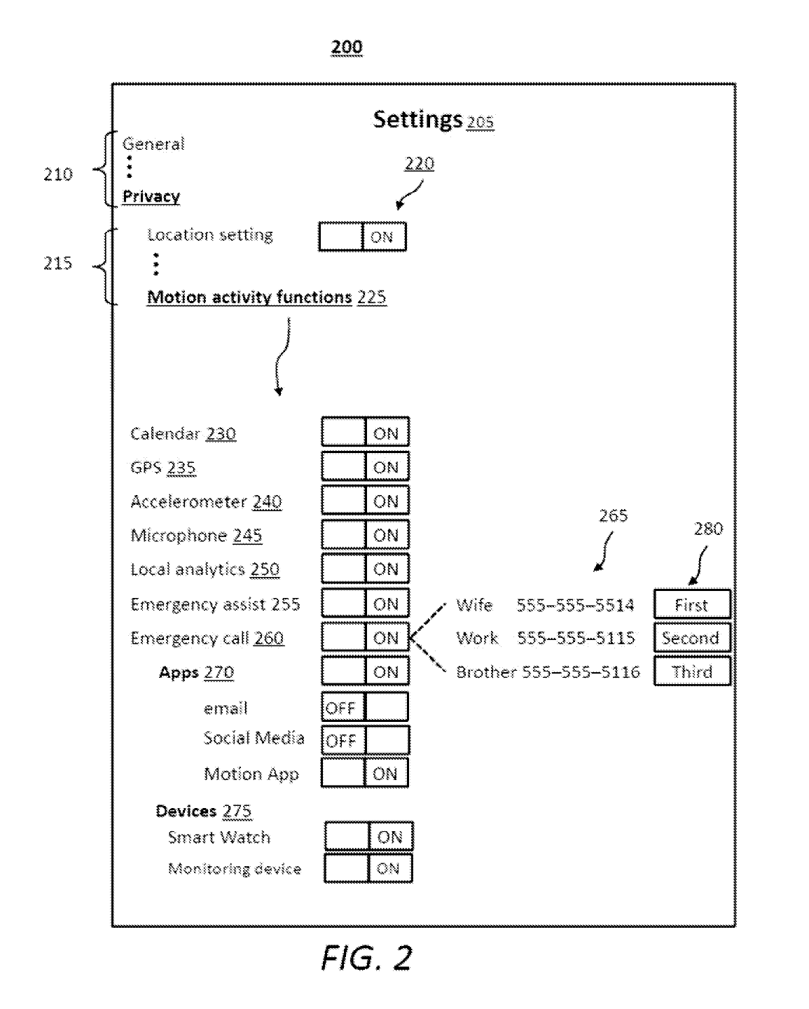

User device 105 may include operating system 135. Operating system 135 may be software that manages the use of hardware, computer programs, and applications of user device 105. Operating system 135 may be, for example, Windows, iOS, OS X, Android, UNIX, or Linux. User device 105 may additionally include settings 140, which may include configurable components of operating system 135. Settings 140 may be modifiable by a user of the user device to alter the performance of operating system 135 and other software on user device 105. In some embodiments, settings 140 may be an application on the user device 105, by which a user may select options and preferences and configure operating system functions. In an example, operating system 135 of user device 105 (e.g., an Apple device) may be iOS, and the settings 140 of user device 105 may be iOS settings. In another example, operating system 135 may be LINUX, and the settings 140 may be LINUX configuration files. In some embodiments, settings 140 may include accelerometer settings, which are modifiable by a user to alter the performance of accelerometer 125 and motion app 150. In some embodiments, settings 140 may be modifiable by a user to configure access to and/or sharing of accelerometer data with applications 195, motion app 150, third party server 160, which may include a third party database (not shown), emergency assistance system 185, and receiver devices 180. Settings 140 are described in detail in connection with FIG. 2. Settings 140 may also be configurable by the user to determine from which external sources accelerometer data may be inputted to user device 105. For example, smart watch 130 and health monitor 120, which may be connected to user device 105 via connection 128.

User device 105 may include any suitable software or applications. In some embodiments, personal assistant software (not shown) runs on user device 105. The personal assistant may be software capable of performing tasks for a user based on, for example, user input, location awareness (e.g., using GPS 155), user settings 140, locally stored information and information accessible over a network (e.g., network 165) from a personal assistant server (not shown), third party server 160, applications 195, a social network (not shown), emergency assistance system 185, receiver devices 180, smart watch 130, and health monitoring device 120. Existing, exemplary, personal assistants include, for example, SIRI™ services (for Apple devices), GOOGLE NOW™ services (for Google Android devices), S VOICE™ (for Samsung devices), and VOICE MATE™ services, (for LG Electronics devices). It will be understood that the examples of existing intelligent personal assistants described herein are merely exemplary, and the system of the present disclosure may be implemented using any suitable hardware and/or software.

In some embodiments, personal assistant software (not shown) is a personal assistant application running on user device 105. Personal assistant software may, for example, send messages, make telephone calls (e.g., emergency calls to specified contacts), set reminders, make calendar appointments, retrieve data locally or remotely, perform internet searches, provide emergency notifications, generate audio or visual output at a speaker or interface of the user device, or perform any other suitable actions in response to user input. In some embodiments, depressing an electromechanical button (e.g., on/off button 115) may activate the personal assistant. In some embodiments, actuating a personal assistant soft key may turn the personal assistant ON or OFF. In some embodiments, a personal assistant on user device 105 may be used to collect accelerometer data, to manage the input and output of accelerometer data, or to provide any other accelerometer data management in accordance with accelerometer settings.

Accelerometer 125 may include any suitable accelerometer software and sensors. Accelerometer sensors may measure acceleration in one, two, and three directions (e.g., x, y, and z directions). Accelerometer sensors may take inertial measurements of velocity and position, measurements of inclination, tilt, or orientation, and/or vibration or impact (e.g., shock) measurements. It will be understood that accelerometer 125 may include any suitable sensors or software.

Applications 195 are software blocks on user device 105, which may be downloaded from remote servers. Applications 195 may provide additional functions for user device 105. For example, applications 195 may be any suitable applications downloaded from, for example, Apple Inc.'s APP STORE® (for Apple devices), GOOGLE PLAY® (for Google Android devices), or any other suitable database or server. In some embodiments, applications 140 may be software, firmware, or hardware that is integrated into the user device 105.

Motion application 150 may be a software block running on user device 105, which may be downloaded from a remote server. Motion application 150 may provide an interface for display of user settings 140 to a user of user device 105. In particular, a user may use motion app 150 to set and view accelerometer settings (described below in connection with FIG. 2), which may be used to provide accelerometer data to third party server 160, emergency assistance system 185, and receiver devices 180. Accelerometer settings may also be set in motion application 150 to specify from which external accelerometer devices accelerometer data may be retrieved. In some embodiments, motion app 150 coordinates accelerometer data retrieved from external accelerometer devices, e.g., smart watch 130 and health monitoring device 120, and accelerometer data generated by accelerometer 125 on user device 105 in order to find events that are related to health and safety of the user (e.g., emergency events) wearing the external accelerometer devices and/or holding the user device 105.

In some embodiments, motion app 150 analyzes all retrieved and locally-generated accelerometer data to provide accelerometer and emergency event data to applications 195 on user device 105, third party server 160, emergency assistance system 185, and receiver devices 180. For example, a calendar function of the motion app may trigger routine collection of accelerometer data and send the data to receiver devices 180 via network 165 and network connections 170. In another example, motion app 150 determines, based on the analysis that a dangerous event is occurring, and may automatically invoke emergency assistance system 185 (e.g., OnStar®) and allow communication between emergency assistance system 185 and user device 105. In some embodiments, all accelerometer data may be continuously sent at various times to third party server 160 for further analysis and distribution to a specified doctor or health professional. In some embodiments, motion app 150 analyzes all retrieved and locally-generated accelerometer data to provide accelerometer and emergency event data to a personal assistant or other software or hardware components of user device 105. For example, motion app 150 may determine that a dangerous event is occurring based on the accelerometer analysis and may send this data to a personal assistant of user device 105, which automatically turns on microphone 110 to receive audio input (e.g., from the user in the dangerous event).

User device 105 is also shown as including local database 145, which may be used to store accelerometer settings and accelerometer data input and outputs. Local database 145 may also store accelerometer data retrieved from external accelerometer-enabled devices, including, for example, smart watch 130 and health monitoring device 120.

Antenna 190 is a component of user device 105. In some embodiments, user device 105 may use antenna 190 to send and receive information wirelessly. For example, antenna 190 may be a cellular data antenna, a Wi-Fi antenna, or a BLUETOOTH® antenna. In some embodiments, antenna 190 is implemented as more than one antenna. In the illustrated embodiment, antenna 190 is used to establish a BLUETOOTH connection with smart watch 130 and health monitoring device 120 and to establish a network connection with third party server 160, emergency assistance system 185, and receiver devices 180 over network 165.

Network connections 170 may include any suitable wired or wireless transmission mediums or channels through which data may be communicated. In the illustrated embodiment, network connections 170 may communicate data between user device 105, network 165, third party server 160, emergency assistance system 185, and receiver devices 180. Network connections 170 may include, for example, a computer networking cable, an Ethernet cable, a cellular communications network, an Internet data trunk (e.g., single transmission channel), a wireless local area network, a wide area network, or a telecommunications network (e.g., 4G wireless network).

Network 165 may include the Internet, a system of interconnected computer networks that use a standard protocol, a dispersed network of computers and servers, a local network, a public or private intranet, any other coupled computing systems, or any combination thereof. In some embodiments, network 165 may be a cloud, which is a network of remote servers hosted on the Internet and used to store, manage, and process data in place of local servers or personal computers. User device 105 may be coupled to network 165 though any suitable wired or wireless connection. In some embodiments, user device 105 may be coupled to network 165 via network connections 170.

Network 165 may allow for communication between the user device 105, third party server 160, emergency assistance system 185, and receiver devices 180 via various communication paths or channels. Such paths or channels may include any type of data communication link known in the art, including TCP/IP connections and Internet connections via Wi-Fi, BLUETOOTH, a Universal Mobile Telecommunications System (UMTS) network, or any other suitable data communication link. In that regard, network 165 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Network 165 allows for communication between any of the various components of network environment 100.

External accelerometer devices may include any suitable remote devices for generating accelerometer data that may be input into user device 105. In the illustrated embodiment, smart watch 130 and health monitoring device 120 are shown as exemplary external accelerometer devices. In the illustrated embodiment, smart watch 130 may include accelerometer 132, time display 134, and antenna 136. It will be understood that smart watch 130 may include any other suitable components. In the illustrated embodiment, health monitoring device 120 may include various monitoring device functions 124, accelerometer 122, and antenna 126. In some embodiments, smart watch 130 and health monitoring device 120 may be connected to user device 105 via connections 128.

Connections 128 may include any suitable wired or wireless transmission mediums or channels through which data may be communicated. In the illustrated embodiment, connections 128 may communicate data between user device 105, smart watch 130, health monitoring device 120, and any other suitable external accelerometer devices (not shown). Connections 128 may include, for example, a computer networking cable, an Ethernet cable, a cellular communications network, an Internet data trunk (e.g., single transmission channel), a wireless local area network, a wide area network, or a telecommunications network (e.g., 4G wireless network). In some embodiments, smart watch 130 and health monitoring device 120 may transmit accelerometer data, collected at each respective device, over connections 128 to user device 105, where it may be stored in local database 145 for local, real-time analysis.

Social network (not shown) may be any suitable networking platform on which a user may share data or post information. The social network may be coupled to user device 105 and network 165 via network connections 170. In some embodiments, the social network may receive user emergency event data in accordance with settings 140, and if permitted by settings 140, the social network may share the user emergency event data with the user's friends, family, connections, or a group of other users defined by the user at settings 140 of the user device or in social network settings.

Third party server 160 may retrieve accelerometer data outputted by user device 105 over network 165. Third party server 160 may be coupled to network 165 and user device 105 by network connections 170. In some embodiments, Third party server 160 may include a third party database (not shown) for storing accelerometer data outputted by user device 105. In some embodiments, accelerometer database may also store user settings (e.g., settings 140) received at third party server 160 for sharing the stored accelerometer data in accordance with the user settings. In some embodiments, as permitted by settings 140, accelerometer data may be transmitted by operating system 135 of user device 105 to third party applications stored in the third party database on third party server 160. In some embodiments, a plurality of other users may also be connected to third party server 160, which manages sharing of accelerometer data among the plurality of users based on respective user settings, which may be stored in the third party database. In some embodiments, a user of user device 105 may link to a second user on a separate user device in settings 140, and the user's accelerometer data may be shared with the linked second user via third party server 160 and third party database.

Third party server 160 and emergency assistance system 185 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

Receiver devices 180 may be any suitable number of remote user devices (e.g., smart phones) that may receive data from and send data to user device 105. In some embodiments, receiver devices 180 may be user devices associated with emergency contacts. For example, the user may specify emergency contacts in user settings 140, and the system may send an emergency notification to receiver devices 180 associated with the specified emergency contacts.

FIG. 2 is a diagram illustrating exemplary settings 200 of an operating system on a user device that may be used with a system for analyzing accelerometer data on a user device. In some embodiments, settings 200 may be displayed on a user interface of user device 105 of FIG. 1. In some embodiments, settings 200 may correspond to settings 140 of user device 105 of FIG. 1. Settings 200 may, for example, provide a mechanism by which a user may alter the functions of an operating system of a user device by implementing changes to settings. Settings 200 may facilitate user interaction with a user device.

Settings 200 may include settings menu 205. Settings menu 205 may include user-editable features for customizing the functionality of an operating system or user device according to user preferences. In some implementations, settings 140 of user device 105 of FIG. 1 are modifiable by a user to alter the performance of operating system 135. In some implementations, settings 140 of user device 105 of FIG. 1 are modifiable to alter the performance of an accelerometer application on user device 105. In some embodiments, settings 200 may be modified by the user interacting with options or commands in a respective settings menu 205. Settings menu 205 may include any number of user-selectable options or commands. Settings menu 205 may include any suitable number of standard operating system or user device settings, for example, standard settings 210, including airplane mode, Wi-Fi, and cellular, as shown in FIG. 2. Standard settings 210 are exemplary interface elements that, when selected by a user, may, for example, redirect the user to a respective new page, window, or dialogue box.

In some embodiments, settings menu 205 includes a list of user-selectable options or settings presented in a hierarchical order. For example, motion activity function settings 225 may be sub-settings under standard settings 210. Standard settings 210 may include a privacy settings option, which is shown as selected (e.g., underlined) in FIG. 2, and the selection of privacy settings may reveal sub-settings 215, including location settings 220, which is shown to be “ON,” and motion activity function settings 225, which is shown as selected (e.g., underlined). Motion activity function settings 225 may include exemplary settings 230-275 that, when selected by a user, may, for example, redirect the user to a respective new page, window, or dialogue box. In another example, when selected, any of the interface elements may expand to reveal sub-options, sub-commands, or any other suitable settings display elements.

In some embodiments, motion activity function settings 225 may include user-editable features for customizing the functionality of an accelerometer running on a user device. In some embodiments, motion activity function settings 225 may be used to customize the functionality of an operating system with respect to use of accelerometer data on a user device (e.g., user device 105 of FIG. 1). As illustrated in FIG. 2, motion activity function settings 225 may include a mechanism for selection and de-selection of automatic personal assistance settings. In the shown embodiment, on/off selection buttons are illustrative examples of mechanisms for selection and de-selection of automatic personal assistance settings. In some embodiments, selection and de-selection in settings menu 205 are binary selections.

In some embodiments, motion activity function settings 225 includes a sub-menu of accelerometer settings 230-275, which are user-selectable options or commands for determining the functionality of auto suggest software running on the user device. The motion activity function settings 225 may include any suitable number of selectable accelerometer settings 230-275, which may correspond to exemplary data to be included or excluded from a status report, as shown in FIG. 2. In the illustrated embodiment, motion activity function settings 225 is selected to be “ON,” indicating the feature is activated.

In the illustrated embodiment, exemplary accelerometer settings 230-275 are shown. Accelerometer settings 220-245 may be used to allow or disallow access to and analysis of accelerometer data. In some embodiments, automatic accelerometer settings 230-275 may be used to configure accelerometer features based on user preferences.

Accelerometer on/off setting 240 allows a user to switch an accelerometer of the user device (e.g., accelerometer software 125 of FIG. 1) on or off. Other exemplary accelerometer settings may be used to configure linking between a local application or external server and the accelerometer of the user device. In some embodiments, accelerometer settings may be used to allow or disallow local applications or external/third party servers access to accelerometer data. If the accelerometer is turned on, which it is in the illustrated embodiment, the user may then configure the sharing of accelerometer data. Using calendar settings 230, a user may switch on or off linking between accelerometer data and a calendar (e.g., calendar application running on a user device) or calendar data. Using GPS (Global Positioning System) settings 235, a user may switch on or off linking between accelerometer data and a GPS (e.g., GPS application 155 of FIG. 1) or GPS data. Using microphone settings 245, a user may switch on or off linking between accelerometer data and a microphone (e.g., microphone 110 of FIG. 1). Using local analytics settings 250, a user may allow or disallow local analysis of the accelerometer data on the user device. Using emergency assist settings 255, a user may switch on or off linking between accelerometer data and an emergency assistance system (e.g., emergency assistance system 185 of FIG. 1). Using emergency call settings 260, a user may allow or disallow an emergency call to be made when the system detects an emergency event based on the accelerometer data. As shown in the illustrated embodiment, emergency call settings 260 is shown as turned “ON,” and a user may also specify which contacts, e.g., people or organizations) to whom the system should place an emergency call. In some embodiments, the user may also specify the order in which the emergency calls should be placed. For example, in the illustrated embodiment, “wife” is shown as the first emergency contact, “work” is shown as the second emergency contact, and “brother” is shown as the third emergency contact. A user may specify any suitable number of emergency contacts in emergency call settings 260. The user may also specify any suitable method of contacting the specified emergency contacts, for example, by phone at a specified phone number, as shown in FIG. 2, or by email, text, or any other suitable communication medium.

App settings 270 are modifiable by a user to allow or disallow connection between the accelerometer and specified applications, including for example, an email application, a social media application (e.g., applications 195 of FIG. 1), and a motion application (e.g., motion app 150 of FIG. 1). In the illustrated embodiment, connections between an email application and a social media application are shown as “OFF,” whereas a connection with a motion application is turned “ON.” It will be understood that a user may add any other suitable applications to the apps setting 270, and access to accelerometer data may be similarly be switched on or off for any additional applications added.

Devices setting 275 are modifiable by a user to allow or disallow connection between the accelerometer and specified devices, including, for example, a smart watch (e.g., smart watch 130 of FIG. 1) and a monitoring device (e.g., health monitoring device 120 of FIG. 1). In the illustrated embodiment, smart watch and monitoring device accelerometer data are both shown as turned “ON” and retrievable by the user device. It will be understood that a user may add any other suitable devices to the devices setting 275, and access to accelerometer data may be similarly be switched on or off for any additional devices added.

It will be understood that the illustrated accelerometer settings are merely exemplary and not provided by way of limitation. Any suitable settings for configuring access to and functions to be performed with accelerometer data may be used. For example, settings may also be used to set which types of outputs of a user device may be used in providing a notification based on an analysis of the accelerometer data (e.g., email, text, phone call, or personal assistant command).

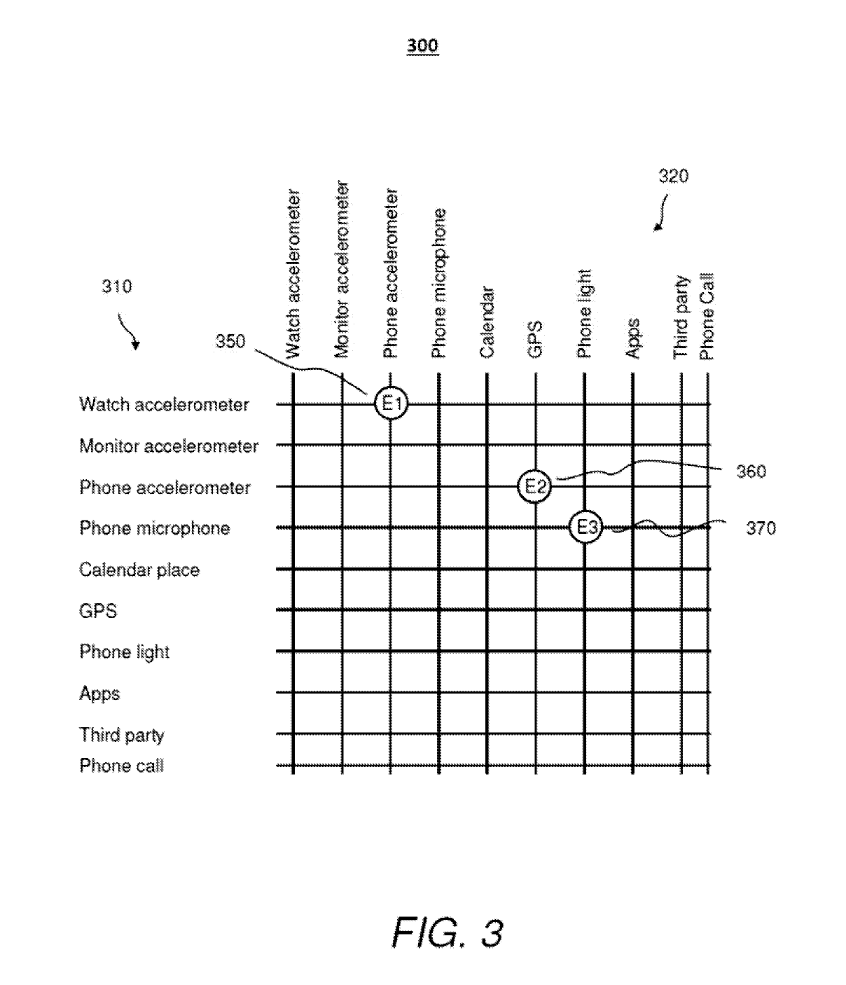

FIG. 3 is a table 300 illustrating exemplary combinations of first data source 310 and second data source 320. Events E1-E3, shown in FIG. 3, correspond to exemplary combinations of two types of data (first source data and second source data) that may be used to identify an emergency event. Table 300 provides exemplary combinations of types of data sources, from which data may be retrieved as a first data source 310 or a second data source 320, including watch accelerometer, monitor accelerometer, phone accelerometer, calendar application, GPS software, phone light, applications, third party sources, and a phone call.

Event E1 presents a scenario 350 in which first data source 310 is a watch accelerometer (e.g., accelerometer software 132 of smart watch 130 of FIG. 1) and second data source 320 is a phone accelerometer (e.g., accelerometer software 125 of user device 105 of FIG. 1). Event E2 presents a scenario 360 in which first data source 310 is a phone accelerometer (e.g., accelerometer software 125 of user device 105 of FIG. 1) and second data source 320 is GPS software (e.g., GPS software 155 of user device 105 of FIG. 1). Event E3 presents a scenario 370 in which first data source 310 is a phone microphone (e.g., microphone 110 of user device 105 of FIG. 1) and second data source 320 is a phone light (e.g., a light, not shown, on user device 105 of FIG. 1). It will be understood that any suitable data sources and any suitable combinations of data sources may be used to identify emergency events.

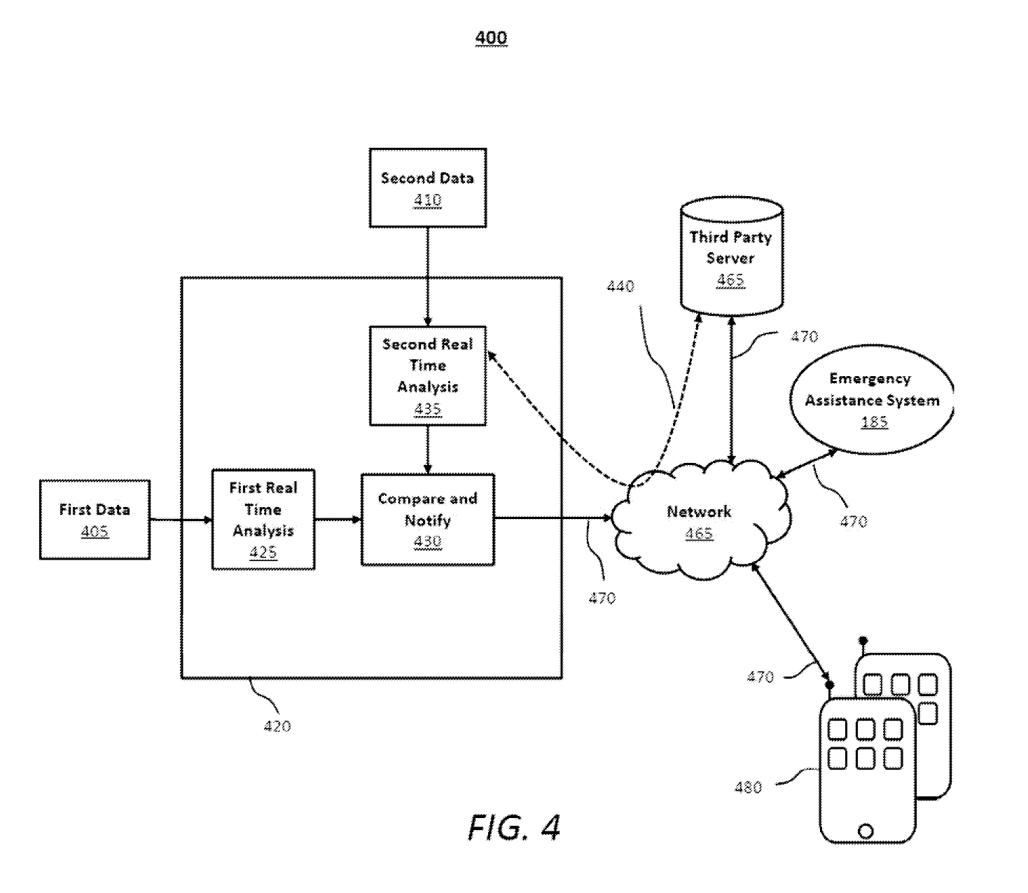

FIG. 4 illustrate another exemplary network environment 400 in which a system for analyzing accelerometer data on a user device may be implemented. In the illustrated embodiment, network environment 400 may involve a user device 415, network 465, network connections 470, third party server 460, emergency assistance system 485, and receiver devices 480. In the illustrated embodiment, user device 415 is connected to network 465 by network connections 470 and to third party server 475, emergency assistance system 485, and receiver devices 480 by network connections 470 and network 465. In some embodiments, user device 415 may correspond to user device 105, network 465 may correspond to network 165, network connections 470 may correspond to network connections 170, third party server 360 may correspond to third party server 160, emergency assistance system 485 may correspond to emergency assistance system 185, and receiver devices 480 may correspond to receiver devices 180 of FIG. 1.

User device 415, which may correspond to user device 105 of FIG. 1 and include all of the elements described in connection with user device 105, may include a motion application 420, which may correspond to motion app 150 of FIG. 1. User device 410 takes receives, via a communications interface, first data 405 and second data 410. In some embodiments, first data 405 is received from a first data source, and second data 410 is received from a second data source. For example, first data 405 may be accelerometer data sent from a smart watch (e.g., smart watch 130 of FIG. 1) and stored in a local database of user device 415 (e.g., local database 145 of user device 105 of FIG. 1). In another example, second data 410 may be accelerometer data from accelerometer sensors of the user device (e.g., accelerometer sensors 125 of user device 105 of FIG. 1) and stored in a local database of user device 415 (e.g., local database 145 of user device 105 of FIG. 1).

Motion app 420 may provide functionality for analyzing accelerometer data from a first data source and a second data source to determine if an emergency event has occurred or is occurring, and to notify one or more emergency contacts of the event. Motion app 150 may take as input first data 405, which is analyzed in first real time analysis 425, and second data 410, which is analyzed in second real time analysis 435. The output of first and second real time analyses 425 and 435 is received by compare and notify 430, which may then communicate with third party server 460, emergency assistance system 485, receiver devices 480 via network 465 and network connections 470. Examples of possible combinations linking a first data source and a second data source are shown in table 300 of FIG. 3, described above.

First real time analysis 425 may include any suitable software and sub-processes for analyzing first data 405, in real time. In some embodiments, first real time analysis 416 includes software that analyzes data from a first sensor such as an accelerometer (e.g., accelerometer 125 of FIG. 1), a GPS (e.g., GPS 155 of FIG. 1), or a microphone (e.g., microphone 110 of user device 105 of FIG. 1). First real time analysis 425 may import first data 405 (e.g., accelerometer data from a smart watch) for analysis. In some embodiments, first real time analysis 425 may analyze the first data 405 to determine whether a potential emergency event exists.

Second real time analysis 435 may include any suitable software and sub-processes for analyzing first data 405, in real time. In some embodiments, second real time analysis 435 includes software that analyzes data from a first sensor such as an accelerometer (e.g., accelerometer 125 of FIG. 1), a GPS (e.g., GPS 155 of FIG. 1), or a microphone (e.g., microphone 110 of user device 105 of FIG. 1). Second real time analysis 435 may import second data 410 (e.g., accelerometer data from an accelerometer on user device 415) for analysis. In some embodiments, second real time analysis 435 may analyze the second data 410 to determine whether a potential emergency event exists.

Compare and notify 430 may include any suitable software and sub-processes for comparing data output from first real time analysis 425 and second real time analysis 435 to determine if an emergency event has occurred. Compare and notify 430 may determine that an emergency event has occurred based on the received data output from the analysis blocks. If compare and notify 430 determines that an emergency event has occurred, or is occurring, then it may generate and send a notification to one or more emergency contacts. Compare and notify 430 may generate an emergency notification based on user settings (e.g., emergency call settings 260 of FIG. 2). For example, compare and notify 430 may send a notification message to emergency assistance system 485 of FIG. 4 via network 465 and network connections 470. The results of compare and notify 430 may also be sent via network 465 and network connections 470 to third party server 460 for further analysis. In some embodiments, third party server 460 may receive emergency event data from a plurality of other user devices, and the third party server 460 may analyze the data received from compare and notify 430 in conjunction with the other received emergency event data to determine if the aggregate data indicates an emergency event. For example, third party server 460 may receive and analyze data from a plurality of user devices showing a large number of individuals were involved in a car accident, and third party server 460 may determine that a area-wide traffic alert should be transmitted.

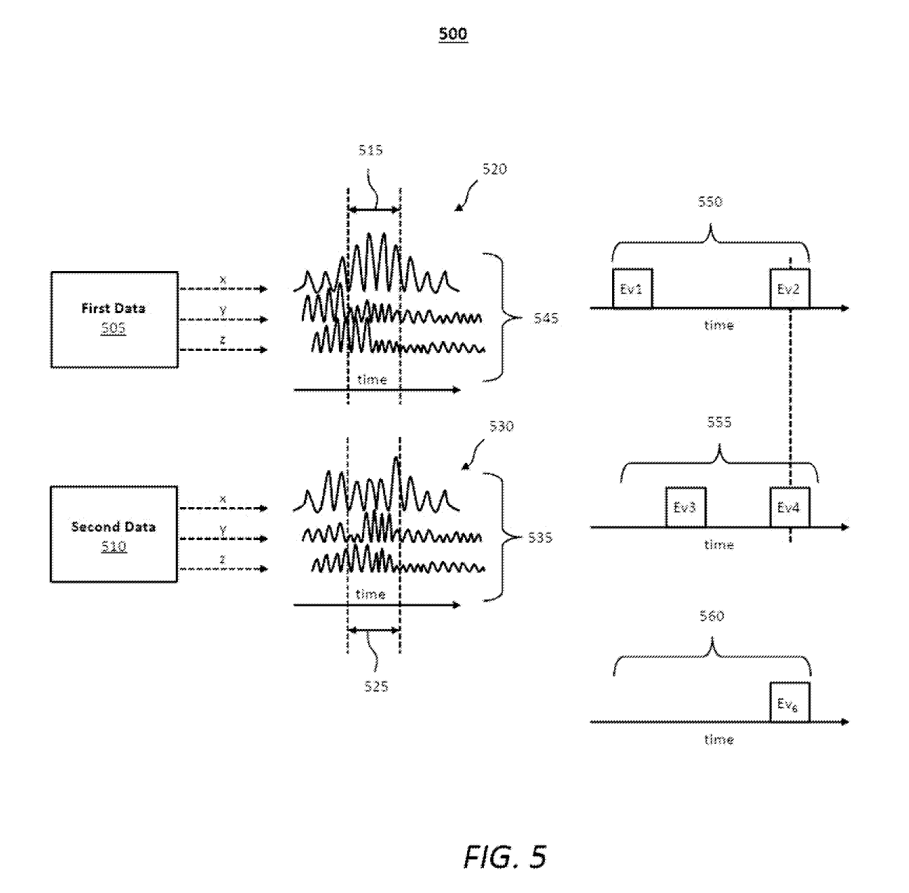

In some embodiments, second data 410 may be sent from second real time analysis block 425 directly to third party server 460 via connection 440, which may be any suitable wired or wireless connection, and network 165 for remote analysis. Third party server 460 may then transmit the results of an analysis of second data to compare and notify block 430 via network 465 and network connections 470. The analysis and comparison of first data 405 and second data 410 is described in more detail below in connection with FIG. 5.

FIG. 5 is an exemplary diagram 500 for analyzing accelerometer data from first and second data sources on a user device. In some embodiments, the system may perform a real time analysis of data from a first data source and data from a second data source, as shown in FIG. 5. As illustrated, diagram 500 includes first data 505, first data stream 520, first emergency event window 515, second data 510, second data stream 530, and second emergency event window 525. In some embodiments, first data 505 and second data 510 respectively correspond to first data 405 and second data 410 of FIG. 4. In some embodiments, first data 505 may correspond to data from a first data source, for example, one of first data sources 310 of FIG. 3. In some embodiments, second data 510 may correspond to data from a second data source, for example, one of second data sources 320 of FIG. 3. In some embodiments, first data 505 may include real time accelerometer data from a first data source for acceleration in the x, y, and z directions. In some embodiments, second data 510 may include real time accelerometer data from a second data source for acceleration in the x, y, and z directions.

First data stream 520 is a stream of accelerometer data from a first data source over time. For example, first data stream 520 may be a real time data feed of accelerometer data from a smart watch (e.g., smart watch 130 of FIG. 1) received at a local database on a user device (e.g., local database 145 of user device 105 of FIG. 1).

First emergency event window 515 may correspond to a window in time corresponding to the occurrence of a potential emergency event. In some embodiments, first emergency event window 515 may be a window of time in which the values of first data 505 for each accelerometer measurement (e.g., one measurement in each of the x, y, and z directions) increase by at least a pre-defined amount. An elevation in x, y, and z acceleration measurements may correspond, for example, to an automobile accident or an earthquake, and first emergency event window 515 spans the time duration during which x, y, and z measurements were elevated by the pre-defined amount. In some embodiments, first emergency event window 515 may correspond to the span of time in which a variation in an accelerometer measurement is of a magnitude greater than a threshold value.

Second data stream 530 is a stream of accelerometer data from a second data source over time. For example, second data stream 530 may be a real time data feed of accelerometer data from a accelerometer sensors (e.g., accelerometer sensors 125 of FIG. 1) received at a local database on a user device (e.g., local database 145 of user device 105 of FIG. 1).

Second emergency event window 525 may correspond to a window in time corresponding to the occurrence of a potential emergency event. In some embodiments, second emergency event window 525 may be a window of time in which the values of second data 510 for each accelerometer measurement (e.g., one measurement in each of the x, y, and z directions) increase by at least a pre-defined amount. An elevation in x, y, and z acceleration measurements may correspond, for example, to a user having fallen down, and second emergency event window 525 spans the time duration during which x, y, and z measurements were elevated by the pre-defined amount. In some embodiments, second emergency event window 525 may correspond to the span of time in which a variation in an accelerometer measurement is of a magnitude greater than a threshold value.

First event horizon 550 may include a list of potential emergency events identified over time based on an analysis of first data stream 520. In some embodiments, first event horizon 550 may correspond to the output of first real time analysis block 425 of FIG. 4. In the illustrated example, the system detected two potential emergency events, Ev1 and Ev2. As shown, first event horizon 550 tracks the occurrence of events as well as the time of each event and the time between events. It will be understood that the system may identify any number of potential emergency events over time based on an analysis of first data stream 520.

Second event horizon 555 may include a list of potential emergency events identified over time based on an analysis of second data stream 530. In some embodiments, second event horizon 555 may correspond to the output of second real time analysis block 435 of FIG. 4. In the illustrated example, the system detected two potential emergency events, Ev3 and Ev4. As shown, second event horizon 555 tracks the occurrence of events as well as the time of each event and the time between events. It will be understood that the system may identify any number of potential emergency events over time based on an analysis of second data stream 530.

Convergence event horizon 560 may include a list of verified emergency events identified over time based on an analysis of first data stream 520 and second data stream 530. In some embodiments, convergence event horizon 560 may correspond to the output from compare and notify block 430 of FIG. 4. When a potential emergency event in first event horizon 550 (e.g., Ev2) occurs at the same time as a potential emergency event in second event horizon 555 (e.g., Ev4), the system may registers an emergency event (e.g., Ev6) in convergence event horizon 560. As convergence event horizon 560 identifies emergency events only when analyses of two data streams from two different data sources both indicate an emergency event at the same time, the emergency events listed in convergent event horizon 560 are verified emergency events, as opposed to the potential emergency events listed in first and second event horizons 550 and 555. In some embodiments, a notification (e.g., emergency call) will only be transmitted, for example, using compare and notify block 430 of FIG. 4, if the emergency event is verified in convergence event horizon 560. For example, emergency event (e.g., Ev6) listed in convergence event horizon 560 is a verified emergency event, and a notification may be generated.

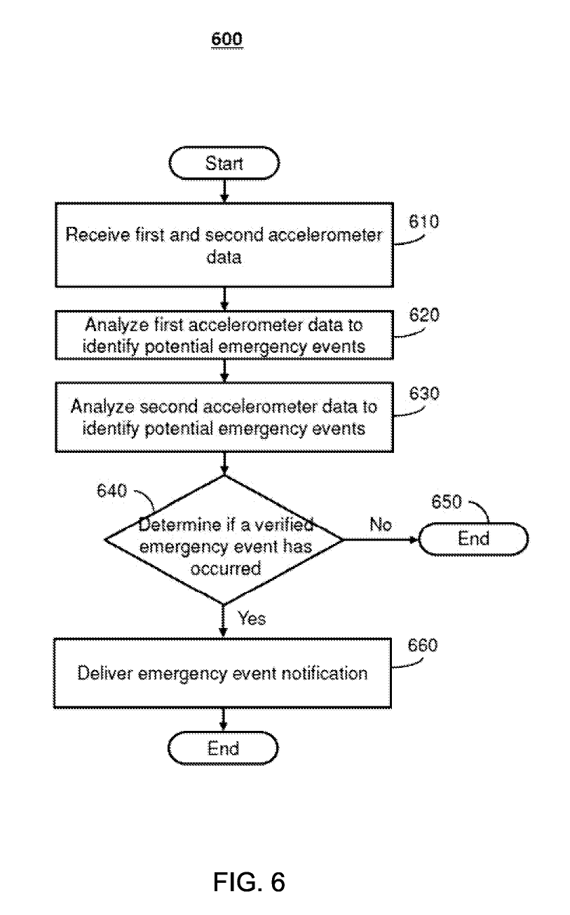

FIG. 6 is a flowchart illustrating an exemplary method 600 for analyzing accelerometer data on a user device. In some embodiments, method 600 is a method for monitoring at least two real time data feeds from at least two sensors to identify an emergency event and to send an emergency notification to one or more emergency contacts.

In step 610, the system receives first accelerometer data in real time from a first data source and second accelerometer data in real time from a second data source. In some embodiments, the first and second data sources are sensors (e.g., sensors of user device 105, smart watch 140 and/or health monitoring device 120 of FIG. 1).

In step 620, the system analyzes the first received accelerometer data to identify first potential emergency events. In some embodiments, the system analyzes the received first accelerometer data over time to identify one or more first potential emergency events, wherein each of the first potential emergency events is associated with a respective first event time window.

In step 620, the system analyzes the second received accelerometer data to identify second potential emergency events. In some embodiments, the system analyzes the received second accelerometer data over time to identify one or more second potential emergency events, wherein each of the second potential emergency events is associated with a respective second event time window.

In step 640 the system compares the first potential emergency events and the second potential emergency events to identify one or more verified emergency events, wherein a verified emergency event is identified when a first event time window associated with a first potential emergency event and a second event time window associated with a second potential emergency event overlap in time. If one or more verified emergency events are identified, the system proceeds to step 660.

In step 650, if no verified emergency events are identified, the system proceeds to “end.”

In step 660, delivers an emergency notification based on the identified one or more verified emergency events.

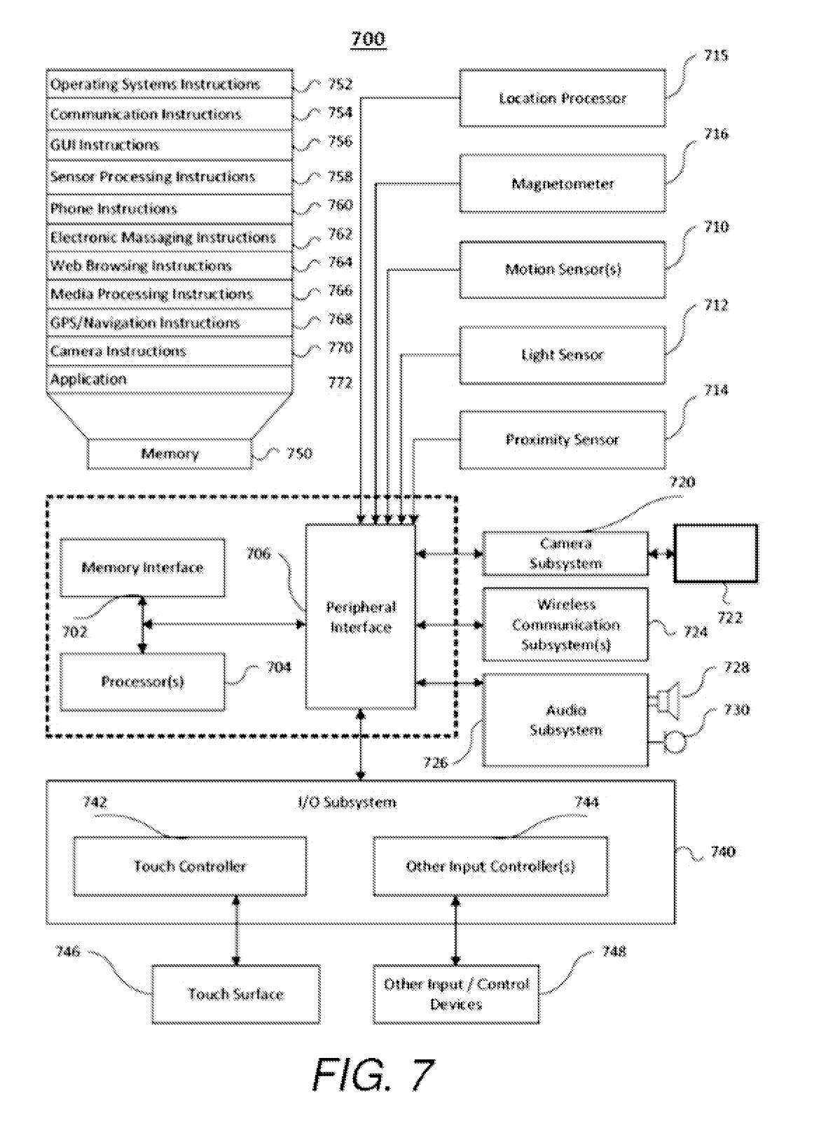

FIG. 7 illustrates a mobile device architecture that may be utilized to implement the various features and processes described herein. Architecture 700 can be implemented in any number of portable devices including but not limited to smart phones, electronic tablets, and gaming devices. Architecture 700 as illustrated in FIG. 7 includes memory interface 702, processors 704, and peripheral interface 706. Memory interface 702, processors 704 and peripherals interface 706 can be separate components or can be integrated as a part of one or more integrated circuits. The various components can be coupled by one or more communication buses or signal lines.

Processors 704 as illustrated in FIG. 7 is meant to be inclusive of data processors, image processors, central processing unit, or any variety of multi-core processing devices. Any variety of sensors, external devices, and external subsystems can be coupled to peripherals interface 706 to facilitate any number of functionalities within the architecture 700 of the exemplar mobile device. For example, motion sensor 710, light sensor 712, and proximity sensor 714 can be coupled to peripherals interface 706 to facilitate orientation, lighting, and proximity functions of the mobile device. For example, light sensor 712 could be utilized to facilitate adjusting the brightness of touch surface 746. Motion sensor 710, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 706, such as a temperature sensor, a biometric sensor, or other sensing device to facilitate corresponding functionalities. Location processor 715 (e.g., a global positioning transceiver) can be coupled to peripherals interface 706 to allow for generation of geo-location data thereby facilitating geo-positioning. An electronic magnetometer 716 such as an integrated circuit chip could in turn be connected to peripherals interface 706 to provide data related to the direction of true magnetic North whereby the mobile device could enjoy compass or directional functionality. Camera subsystem 720 and an optical sensor 722 such as a charged coupled device (CCD) or a complementary metal-oxide semiconductor (CMOS) optical sensor can facilitate camera functions such as recording photographs and video clips.

Communication functionality can be facilitated through one or more communication subsystems 724, which may include one or more wireless communication subsystems. Wireless communication subsystems 724 can include 802.x or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 724 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.x communication networks, code division multiple access (CDMA) networks, or Bluetooth networks. Communication subsystem 724 may include hosting protocols such that the device may be configured as a base station for other wireless devices. Communication subsystems can also allow the device to synchronize with a host device using one or more protocols such as TCP/IP, HTTP, or UDP.

Audio subsystem 726 can be coupled to a speaker 728 and one or more microphones 730 to facilitate voice-enabled functions. These functions might include voice recognition, voice replication, or digital recording. Audio subsystem 726 in conjunction may also encompass traditional telephony functions.

I/O subsystem 740 may include touch controller 742 and/or other input controller(s) 744. Touch controller 742 can be coupled to a touch surface 746. Touch surface 746 and touch controller 742 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 746 may likewise be utilized. In one implementation, touch surface 746 can display virtual or soft buttons and a virtual keyboard, which can be used as an input/output device by the user.

Other input controllers 744 can be coupled to other input/control devices 748 such as one or more buttons, rocker switches, thumb-wheels, infrared ports, USB ports, and/or a pointer device such as a stylus. The one or more buttons (not shown) can include an up/down button for volume control of speaker 728 and/or microphone 730. In some implementations, device 700 can include the functionality of an audio and/or video playback or recording device and may include a pin connector for tethering to other devices.

Memory interface 702 can be coupled to memory 750. Memory 750 can include high-speed random access memory or non-volatile memory such as magnetic disk storage devices, optical storage devices, or flash memory. Memory 750 can store operating system 752, such as Darwin, RTXC, LINUX, UNIX, OS X, ANDROID, WINDOWS, or an embedded operating system such as VxWorks. Operating system 752 may include instructions for handling basic system services and for performing hardware dependent tasks. In some implementations, operating system 752 can include a kernel.

Memory 750 may also store communication instructions 754 to facilitate communicating with other mobile computing devices or servers. Communication instructions 754 can also be used to select an operational mode or communication medium for use by the device based on a geographic location, which could be obtained by the GPS/Navigation instructions 768. Memory 750 may include graphical user interface instructions 756 to facilitate graphic user interface processing such as the generation of an interface; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes, camera instructions 770 to facilitate camera-related processes and functions; and instructions 772 for any other application that may be operating on or in conjunction with the mobile computing device. Memory 750 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 750 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, and communications capability.

The foregoing detailed description of the technology herein has been presented for purposes of illustration and description. It is not intended to be exhaustive or to limit the technology to the precise form disclosed. Many modifications and variations are possible in light of the above teachings. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto

1. A method for analyzing accelerometer data on a user device, the method comprising:
receiving first accelerometer data in real-time from a first data source over a network, wherein the first data source is associated with a first external device in a first location;
receiving second accelerometer data in real-time from a second data source over the network, wherein the second data source is associated with a second external device in a second location; and
executing instructions stored in memory, wherein the execution of the instructions by a processor:
analyzes the received first accelerometer data over time to identify one or more first potential emergency events from a plurality of potential emergency events stored in memory, wherein each of the first potential emergency events is associated with a respective first event time window,
analyzes the received second accelerometer data over time to identify one or more second potential emergency events from the plurality of potential emergency events stored in memory, wherein each of the second potential emergency events is associated with a respective second event time window,
compares the first potential emergency events and the second potential emergency events to identify one or more verified emergency events, wherein a verified emergency event is identified when a first event time window associated with a first potential emergency event and a second event time window associated with a second potential emergency event overlap in time, and
generates an emergency notification based on the identified one or more verified emergency events.

2. The method of claim 1, further comprising receiving user input via a user interface of the user device, wherein the received user input includes accelerometer settings.

3. The method of claim 2, wherein the execution of instructions by the processor further activates an accelerometer feature on the user device based on the user input.

4. The method of claim 3, wherein activating an accelerometer feature on the user device includes executing a motion application on the user device.

5. The method of claim 2, wherein the accelerometer settings are displayed in an interface of a motion application.

6. The method of claim 2, wherein the first and second accelerometer data are received from specified first and second data sources, the first and second data sources specified based on the accelerometer settings.

7. The method of claim 6, wherein the first data source is a first remote device, and wherein the received first accelerometer data is transmitted over the network by the remote device.

8. The method of claim 6, wherein the first data source is a smart watch, and wherein the first accelerometer data is detected by accelerometer sensors of the smart watch.

9. The method of claim 6, wherein the first data source is a health monitoring device, and wherein the first accelerometer data is detected by accelerometer sensors of the health monitoring device.

10. The method of claim 6, wherein the accelerometer settings include allowed remote notification devices.

11. The method of claim 10, further comprising sending the emergency notification over the network to one or more of the allowed remote notification devices.

12. The method of claim 10, wherein the allowed remote notification devices include one or more user devices associated with respective one or more emergency contacts, the emergency contacts specified in the accelerometer settings.

13. The method of claim 10, wherein the allowed remote notification devices include an emergency assistance system.

14. The method of claim 1, further comprising sending verified emergency event data to a third party server over the network, and wherein the third party server processes the verified emergency event data with emergency event data received from a plurality of other user devices to identify emergency events associated with a plurality of users.

15. The method of claim 1, wherein the received first accelerometer data includes one or more accelerometer measurements, and wherein the first event time window is defined by a span of time during which values of the one or more accelerometer measurements exceed one or more threshold values.

16. The method of claim 1, wherein the received second accelerometer data includes one or more accelerometer measurements, and wherein the second event time window is defined by a span of time during which values of the one or more accelerometer measurements exceed one or more threshold values.

17. The method of claim 1, wherein the first accelerometer data is linked with global positioning system data.

18. The method of claim 1, wherein the first accelerometer data is linked with audio input received at a microphone of the user device.

19. An apparatus for analyzing accelerometer data on a user device, the apparatus comprising:
an interface that receives over a network:
first accelerometer data in real-time from a first data source, wherein the first data source is associated with a first external device in a first location, and
second accelerometer data in real-time from a second data source, wherein the second data source is associated with a second external device in a second location; and
a processor that executes the instructions stored in memory to:
analyze the received first accelerometer data over time to identify one or more first potential emergency events from a plurality of potential emergency events stored in memory, wherein each of the first potential emergency events is associated with a respective first event time window,
analyze the received second accelerometer data over time to identify one or more second potential emergency events from the plurality of potential emergency events stored in memory, wherein each of the second potential emergency events is associated with a respective second event time window,
compare the first potential emergency events and the second potential emergency events to identify one or more verified emergency events, wherein a verified emergency event is identified when a first event time window associated with a first potential emergency event and a second event time window associated with a second potential emergency event overlap in time, and
generate an emergency notification based on the identified one or more verified emergency events.

20. A non-transitory computer-readable storage medium, having embodied thereon a program executable by a processor for analyzing accelerometer data on a user device, the method comprising:
receiving first accelerometer data in real-time from a first data source over a network, wherein the first data source is associated with a first external device in a first location;
receiving second accelerometer data in real-time from a second data source over the network, wherein the second data source is associated with a second external device in a second location;
analyzing the received first accelerometer data over time to identify one or more first potential emergency events from a plurality of potential emergency events stored in memory, wherein each of the first potential emergency events is associated with a respective first event time window;
analyzing the received second accelerometer data over time to identify one or more second potential emergency events from the plurality of potential emergency events stored in memory, wherein each of the second potential emergency events is associated with a respective second event time window;
comparing the first potential emergency events and the second potential emergency events to identify one or more verified emergency events, wherein a verified emergency event is identified when a first event time window associated with a first potential emergency event and a second event time window associated with a second potential emergency event overlap in time; and
generating an emergency notification based on the identified one or more verified emergency events.

21. The method of claim 1, wherein the identified one or more verified emergency events include the user being part of a car accident, the user experiencing an earthquake, or the user falling.
